(19) United States
(12) Patent Application Publication
(10) Pub. No.: US 2011/0139771 A1
(43) Pub. Date: Jun. 16, 2011

(54) Series-Parallel Resonant Inverters

(75) Inventors: Nicholas Dohmeier, Surrey (CA); Keith McCormick, Burnaby (CA)

(73) Assignee: Honeywell ASCa Inc., Mississauga (CA)

(21) Appl. No.: 12/959,767

(22) Filed: Dec. 3, 2010

Related U.S. Application Data
(60) Provisional application No. 61/285,946, filed on Dec. 11, 2009.

(51) Int. Cl. H05B 6/04; G05F 3/08

(52) U.S. Cl. 219/661; 323/355

(57) ABSTRACT

A series-parallel resonant inverter inductively couples a switchable DC power source, which has a positive reference voltage node, a negative voltage reference node and a common reference node to a load. The load comprises a parallel resonator that is inductively coupled to the work piece and a series resonator. The series and parallel resonators each preferably has impedance, where the series circuit's impedance is greater than the impedance of the parallel circuit. The series resonator could include a high impedance inductor and a DC blocking capacitor in series with each other.

### RELATED APPLICATION DATA

The present application is claims priority under 35 U.S.C. §119(e) to co-pending application for Series-Parallel Resonant Inverters, Application No. 61/285,946 filed Dec. 11, 2009, which is incorporated herein by reference.

### TECHNICAL FIELD OF THE INVENTION

The present invention generally relates to resonant inverters and particularly to series-parallel resonant inverters particularly useful in industrial induction heating apparatus.

### BACKGROUND OF THE INVENTION

In the operation of an exemplary induction heater, high frequency electromagnetic energy is applied to an electrically conductive work piece to be heated. This electromagnetic energy in turn induces a current flow in the conductive work piece.

In an exemplary induction heater a switched DC power supply drives an inverter which converts the DC source voltage to a high frequency current. A work coil, which is an inductor within the inverter, transfers electromagnetic energy induced by the current in the work coil to the work piece.

The arrangement of the work coil and the work piece can be modeled as an electrical transformer wherein the work coil is the primary winding to which the high frequency current is applied and the work piece is a short circuited single turn secondary winding. From this model it is apparent that high amplitude eddy currents are induced in the work piece. In addition, the high frequency used in induction heater gives rise to a skin effect, which causes the induced currents to flow in a thin layer towards the surface of the work piece. The skin effect increases the effective resistance of the metal to the passage of the large current thereby increasing the heating due to resistive losses.

As seen from the description of the exemplary induction heater, the heating of the work piece is a non-contact process in that heat is generated internally within the work piece from resistive losses as opposed to heat energy, which is developed remotely from the work piece, being directly applied thereto. Accordingly, the heating process does not contaminate the material of the work piece being heated. Moreover, since the heat is actually generated inside the work piece, the heating process is highly efficient.

The exemplary induction heater described above advantageously finds utility in industry. For example, paper production systems often include sets of counter-rotating rolls to compress a paper sheet being formed. The amount of compression provided by the counter-rotating rolls is often controlled through the use of induction heating devices. The induction heating devices create currents in at least one roll in one set of the counter-rotating rolls, which heats the surface of this roll. The heating causes the roll to expand thereby increasing the compression applied to the paper sheet being formed. The expansion due to increasing heat, as well as contraction due to decreasing heat, of the roll is controlled by intensity of the electromagnetic energy used to induce the currents in the roll.

A continuous need exists for increasingly smaller, more efficient, lower cost power conversion technology. In high power induction heating applications, voltage fed resonant inverters are generally employed. Series resonant inverters are often preferred in these applications because of their simplicity resulting in induction heating devices that can be designed with a low component count. Additionally, in series resonant inverters, DC blocking capacitance is inherent and resonant frequency is a function only of the work coil inductance and series resonant capacitance only and does not change with the load.

Series resonant inverters require that the inverter switches be in series with the load, thus they have to carry the full resonant load current. Since the power factor of the load for an induction heating application can be severe, the resonant current can be many times more than the real current into the inverter. This causes additional conduction losses and raises reliability concerns in the event of a timing error in the switch controller or a load fault.

Zero voltage switching can be achieved at close to the resonant frequency. However, during commutation the switch anti-parallel diodes must carry the peak resonant current until the switches take over. This results in stresses on the diodes, reduced reliability, and switching Electromagnetic Interference (EMI) and Electromagnetic Coupling (EMC).

Typical parallel resonant power supplies are less common for such applications because they are more complex in that they require additional components. Moreover, they exhibit high voltage stresses on the switching components and the resonant frequencies varies as the load changes. However, parallel resonant power supplies have the advantage of non-resonant inverter current.

### SUMMARY OF THE INVENTION

Induction heating for pulp and paper applications is characterized by a load, which typically does not change significantly. As such, a series-parallel resonant topology has significant advantages. These advantages include high input voltage operation, fault tolerance, non-resonant inverter current, low or zero-current switching, and multiple inverters from a common DC bus.

The present invention is directed to a combination series-parallel resonant topology that exhibits the advantages both series and parallel single resonance topologies, but that is primarily a parallel resonant converter. The parallel resonance is the dominant resonant network that includes the work coil (or resonant transformer) and work coil capacitance. This is driven by a higher impedance, series resonant network that includes a dedicated inductor and capacitor. The inverter drives at or slightly below the resonant frequency of the entire series-parallel network. The parallel resonant tank's resonant frequency is changed by the load, and thus the resonant frequency of the entire series-parallel network is complicated to calculate.

The input impedance and peak power requirements of this topology are advantageously reduced by the dual resonance. As a result, a sufficiently capacitive DC bus can power one or more capacitor-inductor series inverters (CL) an inductor-capacitor parallel inverters (LC) for implementation of full-bridge series parallel resonant inverters (CLLC) with negligible interference. The high impedance of the series resonant components also permits high voltage operation, vastly improving efficiency, cost and size when compared with lower voltage topologies.

Another advantage is that the inverter switches primarily carry the real current before resonant magnification, significantly lower switch losses can be realized. At close to resonant frequency operation, very low or zero current switching can be achieved thereby eliminating turn on and turn off losses. Diodes conduct a negligible current during switch transition that significantly improves electromagnetic interference and electromagnetic coupling and reduces switching stress.

In one aspect, the invention is directed to a series-parallel resonant inverter for inductively coupling a switchable DC power source, which has a positive reference voltage node, a negative voltage reference node and a common reference node to a load. The load comprises a parallel resonator that is inductively coupled to the work piece and a series resonator. The series and parallel resonators each preferably has impedance, where the series circuit's impedance is greater than the impedance of the parallel circuit. The series resonator could include a high impedance inductor and a DC blocking capacitor in series with each other.

Alternatively, the parallel resonator can include a work coil, or a transformer, and a capacitor coupled in parallel. The parallel resonator could further include a DC current limiter resistance in series with the work coil. This series-parallel resonant inverter would have a resonant frequency selected commensurately with a frequency of the switchable DC power or have the resonant frequency dependent upon the load.

These and other objects, advantages and features of the present invention will become readily apparent to those skilled in the art form a study of the following Description of the Exemplary Preferred Embodiments when read in conjunction with the attached Drawing.

### BRIEF DESCRIPTION OF THE DRAWING

FIG. 1 illustrates embodiments of DC Bus, rectification and filtering;

FIG. 2A illustrates an embodiment of an inverter module in accordance with the present invention;

FIG. 2B illustrates an alternate embodiment of an inverter module in accordance with the present invention;

FIG. 3 illustrates a facet of an alternate disposition of the parallel resonant tank of FIG. 2; and

FIG. 4 illustrates the output of the inverter module of FIG. 2.

### DESCRIPTION OF THE EXEMPLARY PREFERRED EMBODIMENTS

FIG. 1 illustrates a typical AC-DC converter 10 with rectification and filtering from which a stable DC source can be developed from a conventional 3-phase power source. An alternating voltage current undergoes electromagnetic interference and electromagnetic coupling filtering 12. The signal is next rectified by a diode rectifier 14. A final set of inductors 16 and capacitors 18, 20 filters out any remaining AC signal to generate an essentially pure DC output. This is possible as the impedance of a capacitor is Z(w)=1/(jwC) and the impedance of an inductor is Z(w)=jwL. Here, Z(ω) is the impedance as a function of the natural frequency, C is the capacitance, L is the inductance, j is an imaginary value and ω is the natural frequency, a high value near infinity in the ideal case for an AC signal.

As such, the ideal embodiment yields infinite impedance for an inductor and zero impedance for a capacitor. Therefore, an AC signal cannot pass through an inductor but can pass through a capacitor in the ideal case. As such in FIG. 1, an AC signal cannot pass to the DC output via the inductor due to infinite impedance and/or can pass directly to ground via the capacitor.

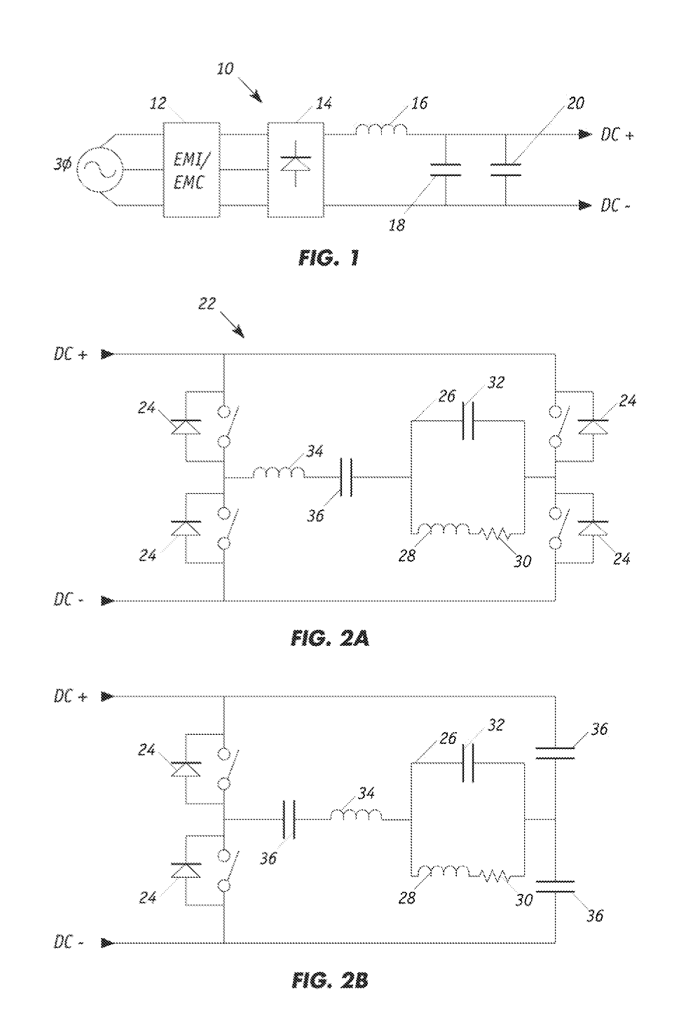

FIG. 2A illustrates an exemplary embodiment of a series (CL)-parallel (LC) inverter module 22. It is to be recognized that there can be one or more modules 22 per system. The module 22 includes diodes 24 which function similar to a diode bridge. The module 22 also supports a parallel resonant tank 26 for primary resonance, whose components are the work coil 28, a current limiter 30 and the parallel resonant capacitor 32. These components see the full resonant currents and voltages and are selected appropriately.

Likewise there is a series resonant component composed of an inductor 34 and a capacitor 36. The series resonant circuit's component values are selected to effectively increase the impedance of the parallel tank circuit 26 and load as seen by the full bridge inverter. DC blocking is facilitated by the series capacitance 36 and the inductor 34 is sized so that at operating frequencies the load will remain net inductive in the event of parallel tank 26 or load change and so that enough energy is provided by the inductor such that inverter input current ripple is minimized. The overall impedance of the entire system is sized to facilitate high input voltage operation. Operating frequency is selected to obtain the desired maximum output power and low switching losses and stresses and output power is varied by duty-cycling.

FIG. 3 illustrates an alternative embodiment of FIG. 2A where the work coil 28 and current limiter 30 is replaced by resonant transformer 40, diode rectifier 42 and load 44. The transformer should be calibrated to a value similar to the effective inductance of the work coil 28.

In the above FIG. 2A and FIG. 3, the operational frequency, fᵣₑₛₒₚᵣ, which will result in minimal or zero current switching, is

$${f}_{resopr} ≅ \frac{1}{2 π \sqrt{( \frac{{L}_{s} \times {L}_{p}}{{L}_{s} + {L}_{p}} ) {c}_{p}}} \times \sqrt{1 - ( {R}^{2} \frac{{C}_{p}}{{L}_{p}} )} .$$

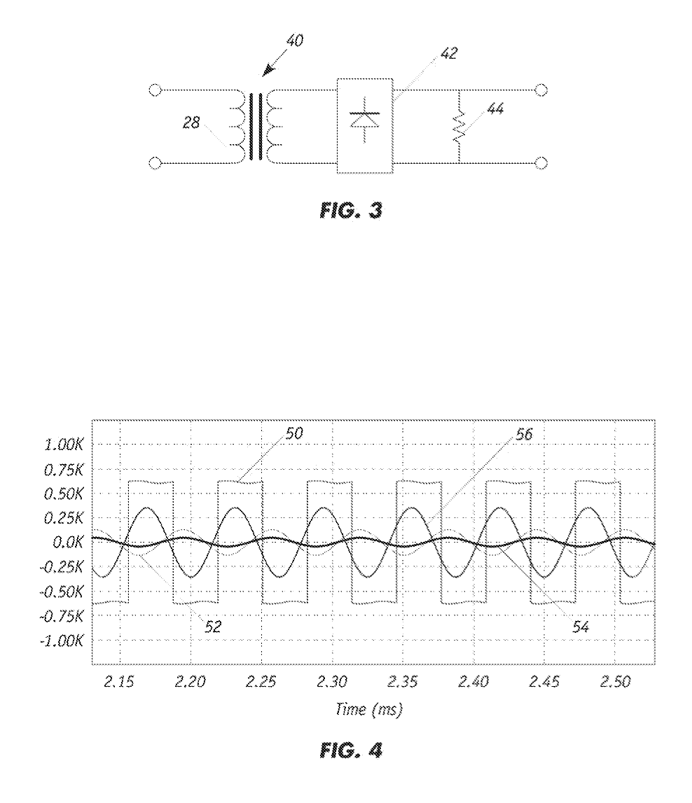

In FIG. 4, the output of the inverter module of FIG. 2A or FIG. 3 is illustrated. Curve 50 illustrates the inverter output voltage. Curve 52 is the work coil or resonant transformer current. Curve 54 is the inverter current and curve 56 is the same inverter current magnified ten times for clarity. Note that the inverter current has minimal or zero amplitude, which results in minimal or zero current switching.

The series inverter as shown in FIG. 2A shows the inductor and capacitor in the typical series connection. In exemplary alternate embodiments of the present invention, the inductor and capacitor, although remaining in series within the circuit need not be directly coupled to each other. For example, either one of the capacitor or the inductor of the series inverter can be placed in series between the DC power source and the parallel inverter and the other one of the capacitor or the inductor of the series inverter can be placed in series between the parallel inverter and the common reference node, represented.

In other alternate embodiments, a second series inverter similar in construction to the series inverter of FIG. 2A can be place in series between the parallel inverter and the common reference node. In a series-parallel inverter configuration, as best seen in FIG. 2A, a series coupled inductor can follow the parallel inverter. In a modified series-parallel configuration in which the series inverter follows the parallel inverter, a series coupled capacitor can precede parallel inverter.

With reference to FIG. 2B, one such alternate embodiment is shown in which additional series capacitors 36a, are placed following the parallel resonant inverter 26. In such embodiment, the additional capacitors 36a may also replace the two of the diodes 24 and switches in the diode bridge of the power source 10.

There has been described above a novel series parallel resonant inverter. Those skilled in the art may now make numerous uses of, and departures from, the above described embodiments without departing from the inventive concepts disclosed herein.

What is claimed as the invention is:

1. A series-parallel resonant inverter for inductively coupling a switchable DC power source having a positive reference voltage node, a negative voltage reference node and a common reference node to a load comprising:
a parallel resonant inverter inductively coupled to said load and having a first node and a second node; and
a series resonant inverter having a first node and a second node; wherein said first node of said series resonant inverter is electrically coupled to said common reference node, said second node of said series resonant inverter is electrically coupled to said first node of said parallel resonant inverter and said second node of said parallel resonant inverter is electrically coupled to said common reference node.

2. A resonant inverter as set forth in claim 1 wherein said series resonant inverter and said parallel resonant inverter each have an impedance, said impedance of said series resonant inverter being higher than said impedance of said parallel resonant inverter.

3. A resonant inverter as set forth in claim 1 wherein said series resonant inverter includes a high impedance inductor and a DC blocking capacitor coupled in series to each other between said first node and said second node of said series resonant inverter.

4. A resonant inverter as set forth in claim 1 wherein said parallel resonant inverter includes a work coil and a capacitor coupled in parallel with said work coil between said first node and said second node of said parallel resonant inverter.

5. A resonant inverter as set forth in claim 4 wherein said work coil and said load together form a resonant transformer, said work coil being a primary winding of said resonant transformer.

6. A resonant inverter as set forth in claim 4 wherein said parallel resonant inverter further includes a DC current limiter resistance in series with said work coil.

7. A resonant inverter as set forth in claim 1 wherein said inverter has a resonant frequency selected commensurately with a frequency of said switchable DC power source.

8. A resonant inverter as set forth in claim 7 wherein said parallel resonant inverter has a resonant frequency dependent upon said load.

9. A resonant inverter as set forth in claim 1 further comprising a second series resonant inverter having a first node and a second node wherein said second series resonant inverter is electrically coupled intermediate said second node of said parallel resonant inverter and said common reference node such that said second node of said parallel resonant inverter is electrically coupled to first node of said second series resonator and said second node of said second series resonator is electrically coupled to said common reference node.

10. A resonant inverter as set forth in claim 1 wherein said series resonant inverter includes an inductor and a capacitor, said parallel resonant inverter being electrically connected in series between said inductor and said capacitor.

11. An inductive heating apparatus comprising:
a switchable DC power source having a positive reference voltage node, a negative voltage reference node and a common reference node;
a parallel resonant inverter operable to inductively couple to a load and having a first node and a second node; and
a series resonant inverter having a first node and a second node; wherein said first node of said series resonant inverter is electrically coupled to said common reference node, said second node of said series resonant inverter is electrically coupled to said first node of said parallel resonant inverter and said second node of said parallel resonant inverter is electrically coupled to said common reference node.

12. An inductive heating apparatus as set forth in claim 11 wherein said series resonant inverter and said parallel resonant inverter each have an impedance, said impedance of said series resonant inverter being higher than said impedance of said parallel resonant inverter.

13. An inductive heating apparatus as set forth in claim 11 wherein said series resonant inverter includes a high impedance inductor and a DC blocking capacitor coupled in series to each other between said first node and said second node of said series resonant inverter.

14. An inductive heating apparatus as set forth in claim 11 wherein said parallel resonant inverter includes a work coil and a capacitor coupled in parallel with said work coil between said first node and said second node of said parallel resonant inverter.

15. An inductive heating apparatus as set forth in claim 14 wherein said work coil and said load together form a resonant transformer, said work coil being a primary winding of said resonant transformer.

16. An inductive heating apparatus as set forth in claim 14 wherein said parallel resonant inverter further includes a DC current limiter resistance in series with said work coil.

17. An inductive heating apparatus as set forth in claim 11 wherein said inverter has a resonant frequency selected commensurately with a frequency of said switchable DC power.

18. An inductive heating apparatus as set forth in claim 17 wherein said parallel resonant inverter has a resonant frequency dependent upon said load.

19. An inductive heating apparatus as set forth in claim 11 further comprising a second series resonant inverter having a first node and a second node wherein said second series resonant inverter is electrically coupled intermediate said second node of said parallel resonant inverter and said common reference node such that said second node of said parallel resonant inverter is electrically coupled to first node of said second series resonant inverter and said second node of said second series resonant inverter is electrically coupled to said common reference node.

20. An inductive heating apparatus as set forth in claim 11 wherein said series resonant inverter includes an inductor and a capacitor, said parallel resonant inverter being electrically connected in series between said inductor and said capacitor.
